(19) United States
(12) Patent Application Publication
(10) Pub. No.: US 2021/0287255 A1
(43) Pub. Date: Sep. 16, 2021

(54) METHOD FOR DETERMINING PRICES OF ONLINE ADVERTISEMENT SPACES

(71) Applicant: BROW.SI MOBILE LTD., Ramat Gan (IL)

(72) Inventors: ALLON HAMMER, TEL AVIV-YAFO (IL); LIOR FISHER, TEL AVIV-YAFO (IL); ASAF SHAMLY, TEL AVIV-YAFO (IL)

(21) Appl. No.: 16/819,353

(22) Filed: Mar. 16, 2020

(51) Int. Cl. G06Q 30/02

(52) U.S. Cl. CPC G06Q 30/0275; G06Q 30/0283; G06Q 30/0277

(57) ABSTRACT

A computer-implemented method performed in preparation for a real time bidding process for determining a dynamic floor price of content items viewed by users, the method including collecting page information and information related to multiple users over time, receiving a view request to view a specific content item by a computerized device operated by a specific user, collecting real-time information concerning the specific user and the specific content item after receiving the view request to view the specific content item, determining the dynamic floor price for the specific content item for a specific user in a specific time slot based on the real-time information, the page information and the information related to multiple users over time and issuing an ad request for an ad impression to advertisement demand sources that includes the specific content item, the specific time slot and the specific ad placement.

### FIELD

The invention relates to the field of online advertisement, in particular a method for determining floor prices of online advertisement spaces.

### BACKGROUND

Online advertising involves the presentation of display or video playing of advertisements (e.g., banner ads, images, text, and/or hyperlinks of various shapes and sizes) embedded into content items such as web pages or mobile application displays that are rendered and displayed to users. For example, when an Internet user enters a Uniform Resource Locator (URL) into the address bar of a browser application and directs the browser application to request the web page corresponding with the URL, the web page that is rendered and displayed to the user may include one or more display/video advertisements. The content publisher (e.g., the operator of the website/mobile applications, also defined below as “App”) may desire to generate revenue by offering to advertisers' ad space on web pages for the display of advertisements.

There are a many methods, techniques and mechanisms by which content publishers can make their ad spaces available to advertisers for purchasing, and by which advertisers can find and purchase the ad spaces of content publishers. One way is through direct negotiation, in which an advertiser directly approaches a publisher with a request to purchase ad space in the publisher's web pages. Another way that a publisher may offer ad space for sale is through an ad network or ad exchange. Ad networks and ad exchanges are companies that connect content publishers with advertisers who desire to have ads embedded in the publishers' websites. Ad networks and ad exchanges operate in a variety of different ways. For instance, some are highly automated such that both the content publisher and advertiser can conclude transactions via web-based interfaces, without additional personal interaction.

Pricing of the ad space of the publisher's websites may be determined based on an auction between multiple advertisers. However, the publisher may define a floor price, such that in case all the offers for a specific ad space are lower than the floor price, none of the bidders can place an ad in the ad space. Floor price computation is more complicated in real-time bidding (RTB), in which a typical transaction begins with a user requests to view a content item, such as a web page. This view request triggers a bid request that can include various pieces of data such as the user's demographic information, browsing history, location, and identifier of the content item being requested. The ad request goes from the publisher to an ad exchange, which submits it and the accompanying data to multiple advertisers who automatically submit bids in real time, before the content item is loaded on the user's computerized device, to place their ads. Advertisers bid on each ad impression as it is served. The impression goes to the highest bidder and their ad is served on the page.

The bidding is performed autonomously, and advertisers may set maximum bids and budgets for an advertising campaign. The criteria for bidding on particular types of consumers can be very complex, taking into account everything from very detailed behavioral profiles to conversion data. Probabilistic models can be used to determine the probability for a click or a conversion given the user history data. This probability can be used to determine the size of the bid for the respective advertising slot.

### SUMMARY

In one aspect of the invention a computer-implemented method is provided, performed during a real time bidding (RTB) process for determining a dynamic floor price of content items viewed by users over the internet, the method including collecting page information and information related to multiple users over time, receiving a view request to view a specific content item by a computerized device operated by a specific user of the multiple users, collecting real-time information concerning the specific user and the specific content item after receiving the view request to view the specific content item, determining the dynamic floor price for the specific content item for a specific user in a specific time slot based on the real-time information, the page information and the information related to multiple users over time, issuing an ad request for an ad impression to advertisement demand sources, the ad request includes the specific content item, the specific time slot and the specific ad placement.

In some cases, the method further includes sending the dynamic floor price to the specific content item and to bidders. In some cases, the method further includes receiving bids from multiple bidders for placing advertisements in the specific content item in the specific time slot and choosing a bid winner from the multiple bidders. In some cases, the method further includes computing multiple dynamic floor prices for the specific content item for a specific user in a specific time slot, each floor price of the multiple dynamic floor prices is associated with a specific bidder of the multiple bidders. In some cases, the method further includes obtaining prior bids for ad placements associated with the specific user and the specific content item.

In some cases, the method further includes inputting the prior bids, the real-time information, the page information and the information related to multiple users over time into an Artificial Intelligence (AI) engine, inputting historic inventory information into the AI engine, the AI engine computing weights for each vector of multiple vectors used to compute the dynamic floor price for the specific content item for a specific user for a specific ad placement in a specific time slot, the AI engine computing using the weights to compute the dynamic floor price for the specific content item for a specific user in a specific time slot.

In some cases, the multiple vectors include user data, page data and historic data. In some cases, the method further includes obtaining a time-based series of revenues for the specific content item, predicting revenues for the specific content item in the specific time slot time-based series of revenues for the specific content item and the real-time information concerning the specific user and the specific content item. In some cases, the method further includes performing an extrapolation from the time-based series to estimate a revenue in the specific time slot. In some cases, the method further includes performing a secondary bid between the dynamic floor price for the specific content item for a specific user in a specific time slot and external offers. In some cases, the ad request includes the dynamic floor price.

In some cases, the advertisement demand sources include ad servers, ad exchanges and supply side platforms.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 discloses a method for collecting information for computing a dynamic floor price for a specific content item in a specific time slot, according to exemplary embodiments of the invention;

FIG. 2 discloses a method for using a dynamic floor price for a specific content item in a specific time slot when executing a bid for the specific content item in a specific time slot, according to exemplary embodiments of the invention;

FIG. 3 discloses a method for computing a dynamic floor price for a specific content item in a specific time using an artificial intelligence engine, according to exemplary embodiments of the invention;

FIG. 4 discloses a computerized environment for executing bids on ad placements and computing a dynamic floor price for a specific content item in a specific time slot, according to exemplary embodiments of the invention;

FIG. 5 discloses a method for computing a dynamic floor price for a specific content item in a specific time slot, according to exemplary embodiments of the invention; and,

FIG. 6 discloses a computerized environment for executing bids on ad placements and the steps performed by various entities in the environment, according to exemplary embodiments of the invention.

### DETAILED DESCRIPTION

The invention discloses a method for determining floor prices for placing advertisements in ad placements in content items. The method is performed prior to and as preparation for a real time bidding process, in which the bidding that determines which advertisement is placed in ad placements in the content items is performed after a computerized device sends a request for the content item. The floor price is dynamic and is determined for a specific content item, for a specific time slot in which a specific user wishes to review the specific content item. This way, pricing of the ad placement in the specific content item, for a specific user and in a specific time slot is much more accurate, and the publisher can enjoy higher revenue. Another result of the process disclosed herein is that advertisers pay a floor price which is based on more information, not just general information about the website, but also about the specific user. Additionally, the information used to compute the floor price also includes real-time information which is collected after the request to view the specific content item is received at the web server. As the web server is designed to provide the content of the specific web server within a very short period of time, for example in the range of 300 milliseconds to 3 seconds, the dynamic floor price is computed based on information received within 3 seconds prior to the delivery of the specific content item, said delivery is performed after computation of the dynamic floor price. The dynamic floor price is placed in order to increase publisher revenue and to enforce a policy so buyers (advertisers) will not decrease their bids over time. Keeping publisher's inventory priced in accordance with user and page metrics is a key to ensure that publishers will not lose revenue in an RTB world.

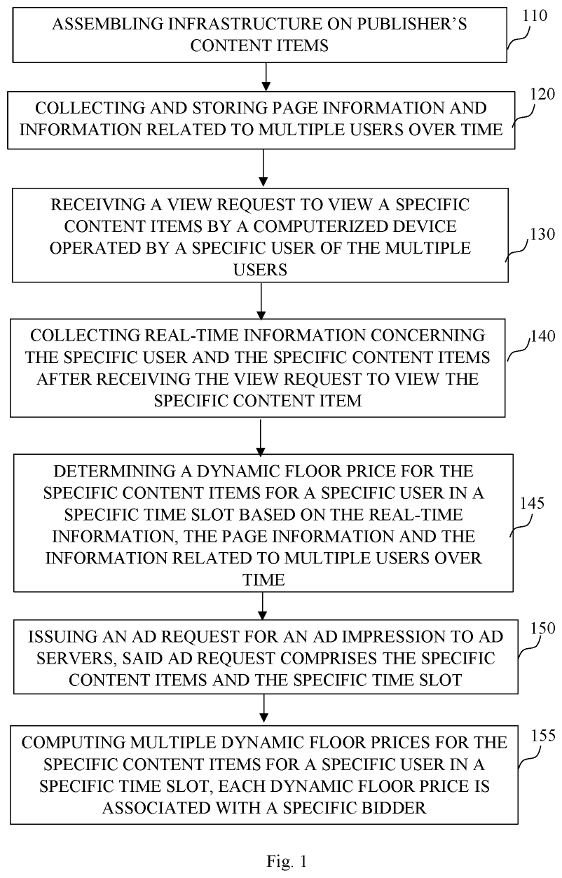

FIG. 1 discloses a method for collecting information for computing a dynamic floor price for a specific content item, according to exemplary embodiments of the invention.

Step 110 discloses assembling infrastructure on publisher's content items. The infrastructure enables the computerized entity that computes the dynamic floor price of the specific content item/app to obtain real time information about the specific content item and about the specific user. The infrastructure may include placing software agents, such as tags on multiple content items owned by the publisher. Placement of the tags is performed in cooperation with the publisher. The publishers may be a news website, a social network website, blogging website and the like. The tags may be embedded inside the software code that runs the content item, such as HTML. The tags may be embedded into the publisher's content items by the entity that computes the dynamic floor price. In another optional embodiment, the infrastructure that enables the computerized entity that computes the dynamic floor price of the specific content item to obtain real time information about the specific content item includes establishing a communication channel between the entity and a header bidding entity which receives information directly from the publisher's content items. Such communication channels may be wired, for example over a physical cable, or may run over the internet or a wireless network desired by a person skilled in the art.

Step 120 discloses collecting and storing page information and information related to multiple users over-time. The page information may be collected using the infrastructure disclosed above. The page information may include number of view requests to view each content item within a time slot, for example during a single hour having a specific time and date. The page information may also include geographic locations from which the view requests were received. The page information may include number of media items in the content item, such as images and videos, number of ad placements in which advertisements are configured to be inserted, number of words, keywords in the content item and the like. The user information may include the time users spent viewing the content item, any feedback inputted by the user into the browser when reviewing the content item, browser type used to view the content item, type of computerized device used by the user who viewed the content item and the like. The user information may include information related to a single user or to multiple users.

The collected page information and information related to multiple users over time may be stored in a server owned and/or controlled by the publisher or by the entity that computes the dynamic floor price for the specific content item. The server may be offline or stored in an online storage platform, such as Amazon web Server (AWS).

Step 130 discloses receiving a view request to view a specific content item by a computerized device operated by a specific user of the multiple users. The view request is inputted onto a web browser and sent to a web server. The web server, or a software agent in the content item, may notify the publisher or the entity that manages the ad placement in the publisher's content items, that such request was made, along with relevant information. The relevant information may include browser type, an identifier of the user associated with the request for the specific content item, type of computerized device used by the user and the like. In some other cases, the web server or a software agent in the content item, may enforce the floor price autonomously.

Step 140 discloses collecting real-time information concerning the specific user and the specific content item after receiving the view request to view the specific content item. The real-time information is obtained in the few seconds, or milliseconds, between the view request until the specific page is displayed on the computerized device of the specific user. The real-time information may include the browsing activity of the user in the time elapsing before the specific user inputted the view request by inputting the specific content item into the browser. The real time information about the specific content item may include the traffic in the specific content item in a short time slot prior to the view request. The time slot may be of a duration in the range of 10 seconds −10 minutes. This information may show the demand in the specific w content item which may influence the floor price. Another property extracted from the content item is users' behavior in the short time slot prior to the view request, how much time the average user spent in the specific content item, any links activated by the user and the like.

Step 145 discloses determining a dynamic floor price for the specific content item for a specific user in a specific time slot based on the real-time information, the page information and the information related to multiple users over time. The entity that computes the dynamic floor price may use a logical function that receives as input multiple parameters' values, such as traffic in the specific content item, trends in the traffic, behavior of the specific user in other content items, likelihood that a specific area in the specific content item is viewed by the specific user and the like. The output of the function is a financial value, such as a number of United States Dollars ($) or a portion thereof.

Step 150 discloses issuing an ad request for an ad impression to advertisement demand sources. The advertisement demand sources may include entities that demand, or regulate demand of advertisement, for example ad servers, ad exchanges and SSPs. The ad request includes the specific content item, the specific time slot and the specific ad placement in the content item. The ad request may be sent from the content item, or from the publisher's server, to an ad server that manages the advertisements for the publisher. The ad request may be sent to a header bidding entity/bidder, that runs a bid between multiple advertisers that showed interest in purchasing an ad placement and placing an ad on the publisher's content item. After receiving an ad impression, the publisher may send a request to compute the dynamic floor price for the specific content item in order to have an accurate floor price for the specific time slot, and not rely on old information, for example rely only on information collected at least one hour prior to receiving the request for the content item.

The entity that runs the computation of the dynamic floor price may provide a different floor price for the same specific user and the same specific content item in a different time slot, for example based on known patterns for viewing content item in different hours in the day. The entity that runs the computation of the dynamic floor price may provide a different floor price for different users wishing to view the same specific content item in the same time slot, for example based on predictions that consider prior users' behavior, users' device type, browser type and the like.

Step 155 discloses computing multiple dynamic floor prices for the specific content item for a specific user in a specific time slot, each dynamic floor price of the multiple floor prices is associated with a specific bidder or with multiple bidders. The entity that computes the dynamic floor prices obtains information from the publisher, or from an entity that manages the publisher's placements. Such information from the publisher may be prior bid values provided from each of the advertisers that participate in the bidding process, or prior ad space acquisitions made by advertisers. This information distinguishes between the multiple advertisers that participate in the bid. This way, a specific auction for a specific user for a specific placement in a specific time-slot had the following bids—advertiser #1—bid 1.50$, advertiser #2—bid 0.50, advertiser #3—bid 0.01$. In one case, setting dynamic floor of 1$—in this case advertiser #2 and #3 will be dismissed and advertiser #3 wins (1.5$ bid). In a different case setting 2 dynamic floor prices—advertiser #1 will have 2$ floor and advertiser #2 and advertiser #3 will have 0.50$ floor. In this case, advertiser #1 is dismissed (as the bid is lower than 2$), advertiser #3 is also dismissed (as the bid is lower than 0.50$) and advertiser #2 wins.

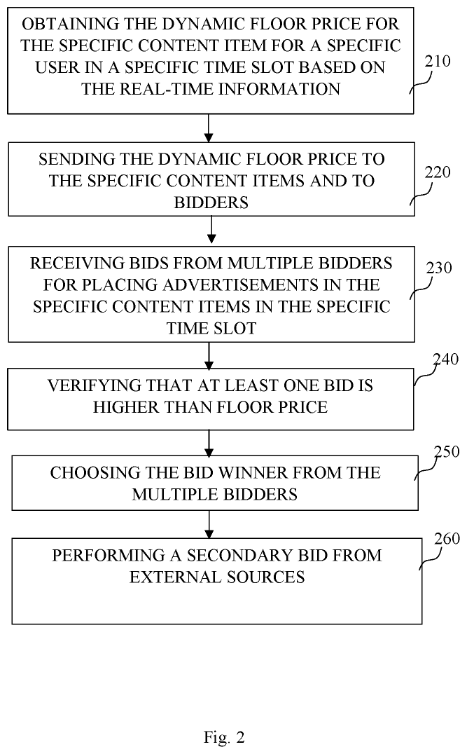

FIG. 2 discloses a method for using a dynamic floor price for a specific content item in a specific time slot when executing a bid for the specific content item in a specific time slot, according to exemplary embodiments of the invention.

Step 210 discloses obtaining the dynamic floor price for the specific content item for a specific user in a specific time slot based on the real-time information. The dynamic floor price is represented as a financial value, for example a numeric value and a currency name, such as 100 Japanese yen. The dynamic floor price may be stored in a memory address and is associated with an identifier of the specific content item for a specific user in a specific time slot. For example, a number of bits represent each of the specific content item for a specific user in a specific time slot.

Step 220 discloses sending the dynamic floor price to the specific content item and to bidders. Sending may be performed over the internet, a cellular network and the like. The dynamic floor price may be stored in a specific address in the memory of the computer and/or server hosting the content item.

Step 230 discloses receiving bids from multiple bidders for placing advertisements in the specific content item in the specific time slot. The bids may be inputted in a computerized manner into an input module, such as a website or an internet portal managed by the header bidding or by another entity running the bid. The bids may be represented by a financial value and a currency name.

Step 240 discloses verifying that at least one bid is higher than floor price. Such verifying may be performed by comparing the bids with the dynamic floor price. In some cases, there are multiple floor prices and each bidder is compared to its unique floor price.

Step 250 discloses choosing the winning bidder from the multiple bidders. The winning bidder may be the bidder that inputted the highest value.

Step 260 discloses performing a secondary bidding process with external sources. The secondary bidding process may be performed in which the winning bid from the header bidding auction, after enforcing the floor price for the specific user, specific time slot and specific content item, is sent to a third party ad server decision process. The third party ad server decision process includes comparing the bids associated with the floor price with direct offers, in which advertisers directly approach the publisher and/or other programmatic offers.

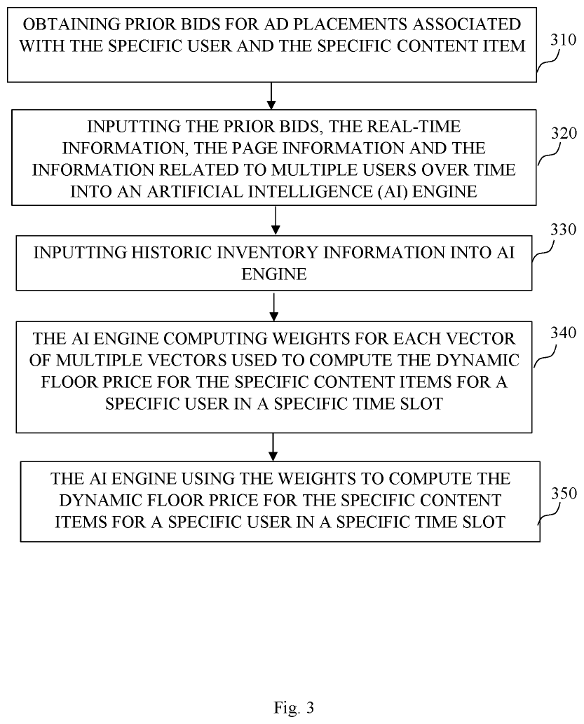

FIG. 3 discloses a method for computing a dynamic floor price for a specific content item in a specific time using an artificial intelligence engine, according to exemplary embodiments of the invention.

Step 310 discloses obtaining prior bids for ad placements associated with the specific user and the specific content item. The prior bids may be stored in a computer or server owned or controlled by the publisher or by the entity that manages sales of the publisher's ad space. The prior bids may include values such as the bidder identifier, bidding value, bid date, the value in which the ad space was sold and the like.

Step 320 discloses inputting the prior bids, the real-time information, the page information and the information related to multiple users over time into an Artificial Intelligence (AI) engine. Such input may be performed by sending a file containing the values into a server operating the AI engine. Other ways of inputting the values may be via an internet portal, or by sending a message over a communication network such as the internet.

Step 330 discloses inputting historic inventory information into AI engine. The historic inventory information may include ad space identifiers, number of sales of the ad spaces, sales values of the ad spaces, entities that bought the ad spaces, user's behavior in the content items that included the ad spaces and the like.

Step 340 discloses the AI engine computing weights for each vector of multiple vectors used to compute the dynamic floor price for the specific content item for a specific user in a specific time slot. The AI engine uses a computer software that receives the information inputted in steps 320 and 330 and outputs a series of weights. The weights are associated with parameters. The weights are determined based on a set of rules stored in the AI engine. The set of rules may change based on the information inputted into the AI engine.

Step 350 discloses the AI engine using the weights to compute the dynamic floor price for the specific content item for a specific user in a specific time slot. The dynamic floor price is represented by a financial value and a currency identifier.

In some exemplary embodiments, the entity that manages the computation of floor prices obtains a time-based series of revenues for the specific content item. The time-based series is defined by revenues received from advertisers per time slot. The time slot's duration may vary, for example from 1 minute to one day. The entity uses the time-based series of revenues for combined with the real-time information concerning the specific user and the specific content item for predicting revenues for the specific content item in the specific time slot. Such prediction may include performing an extrapolation from the time-based series to estimate a revenue in the specific time slot.

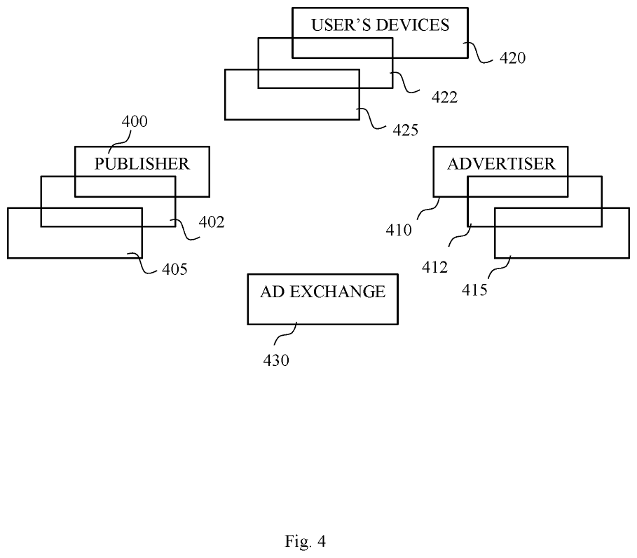

FIG. 4 discloses a computerized environment for executing bids on ad placements and computing a dynamic floor price for a specific content item in a specific time slot, according to exemplary embodiments of the invention.

The computerized environment includes one or more publishers 400, 402, 405 who control and/or own websites and personal computerized devices 420, 422, 425 used by persons or machines to view the content items controlled by the one or more publishers 400, 402, 405.

The computerized environment also includes one or more advertisers 410, 412, 415 wishing to purchase ad spaces on the publisher's website. The one or more advertisers 410, 412, 415 may contact the one or more publishers 400, 402, 405 directly, or via intermediate entities such as ad exchanges 430. The ad exchanges 430 represents the one or more advertisers 410, 412, 415 during the process of purchasing ad spaces at the one or more publishers 400, 402, 405, the advertisements of the advertisers 410, 412, 415 will fill the ad spaces and will be displayed on the displays of the personal computerized devices 420, 422, 425.

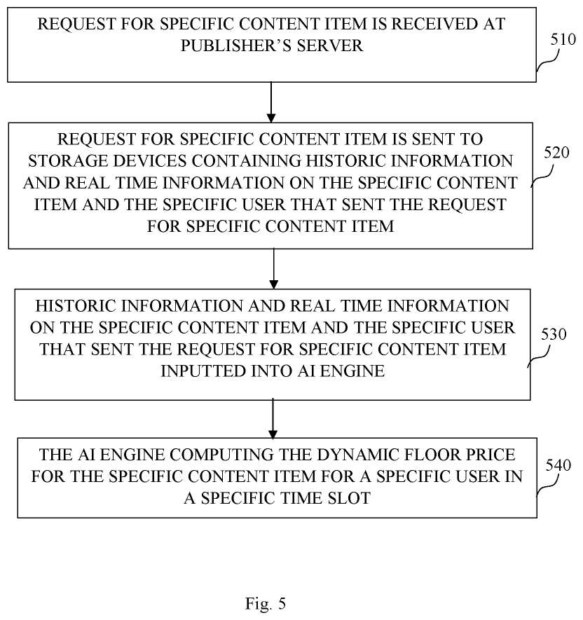

FIG. 5 discloses a method for computing a dynamic floor price for a specific content item in a specific time slot, according to exemplary embodiments of the invention.

Step 510 discloses receiving a request for specific content item at publisher's server. The request may include an identifier of the computerized device in which a user inputted the request, for example by pressing an icon of a mobile application or inputting a URL.

Step 520 discloses sending the request for specific content item to storage devices containing historic information and real time information on the specific content item and the specific user that sent the request for specific content item.

Step 530 discloses inputting historic information and real time information on the specific content item and the specific user that sent the request for specific content item into AI engine.

Step 540 discloses the AI engine computing the dynamic floor price for the specific content item for a specific user in a specific time slot.

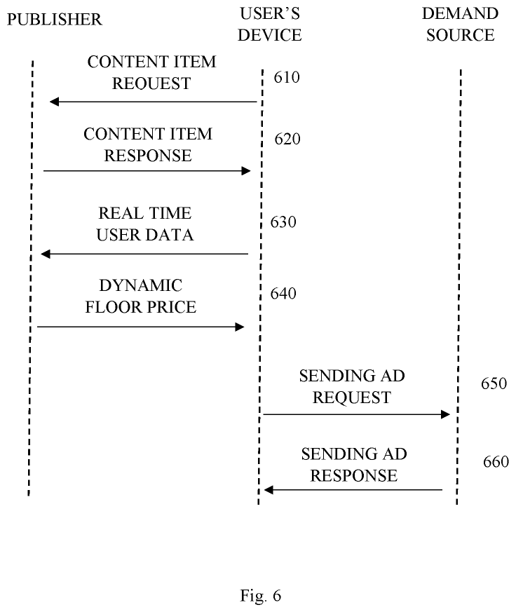

FIG. 6 discloses a computerized environment for executing bids on ad placements and the steps performed by various entities in the environment, according to exemplary embodiments of the invention.

Step 610 discloses sending a content item request from the user's computerized device to the publisher's server. The user's computerized device may be a laptop computer, a tablet, a cellular phone and the like.

Step 620 discloses sending a content item response from the publisher's server to the user's computerized device. The content item response includes the content item, or approval to display the content item, in case the content item is already stored at the user's computerized device. The content item response may contain information as to ad placement in the content item, such as size, location on the page and the like.

Step 630 discloses collecting real time user information from the user's computerized device and sending the real time user information to the publisher's server, where the real time user information is processed.

Step 640 discloses computing the dynamic floor price for the specific user, the specific time slot, and the specific content item. Such computation includes the real time user information as input. The dynamic floor price may be computed at the publisher's server and sent to the user's computerized device.

Step 650 discloses sending a request for advertisement from a computerized agent located in the user's computerized device to advertisement demand sources, such as ad servers, ad exchanges and supply side platforms.

Step 660 discloses sending an ad response from the advertisement demand sources to the user's computerized device. The ad response includes the advertisement, or an identifier of the advertisement.

While the disclosure has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiments disclosed herein.

1. A computer-implemented method performed in preparation for a real time bidding (RTB) process for determining a dynamic floor price of content items viewed by users over the internet, said method comprising:
collecting page information and information related to multiple users over time;
receiving a view request over the Internet to view a specific content item by a computerized device operated by a specific user of the multiple users;
collecting real-time information over the Internet concerning the specific user and the specific content item after receiving the view request to view the specific content item;
determining the dynamic floor price for the specific content item for a specific user in a specific time slot based on the real-time information, the page information and the information related to multiple users over time;
issuing an ad request for an ad impression to advertisement demand sources, said ad request comprises the specific content item, the specific time slot and the specific ad placement.

2. The method of claim 1, further comprises sending the dynamic floor price of the specific content item and to bidders.

3. The method of claim 1, further comprises receiving bids from multiple bidders for placing advertisements in the specific content item in the specific time slot and choosing a bid winner from the multiple bidders.

4. The method of claim 3, further comprises computing multiple dynamic floor prices for the specific content item for a specific user in a specific time slot, each floor price of the multiple dynamic floor prices is associated with a specific bidder of the multiple bidders.

5. The method of claim 1, further comprises obtaining prior bids for ad placements associated with the specific user and the specific content item.

6. The method of claim 5, further comprises inputting the prior bids, the real-time information, the page information and the information related to multiple users over time into an Artificial Intelligence (AI) engine;
inputting historic inventory information into the AI engine;
the AI engine computing weights for each vector of multiple vectors used to compute the dynamic floor price for the specific content item for a specific user for a specific ad placement in a specific time slot;
the AI engine computing using the weights to compute the dynamic floor price for the specific content item for a specific user in a specific time slot.

7. The method of claim 6, wherein the multiple vectors comprise user data, page data and historic data.

8. The method of claim 1, further comprises obtaining a time-based series of revenues for the specific content item;
predicting revenues for the specific content item in the specific time slot time-based series of revenues for the specific content item and the real-time information concerning the specific user and the specific content item.

9. The method of claim 8, further comprises performing an extrapolation from the time-based series to estimate a revenue in the specific time slot.

10. The method of claim 1, further comprises performing a secondary bid between the dynamic floor price for the specific content item for a specific user in a specific time slot and external offers.

11. The method of claim 1, wherein the ad request comprises the dynamic floor price.

12. The method of claim 1, wherein the advertisement demand sources comprise ad servers, ad exchanges and supply side platforms.
